(19) United States
(12) Patent Application Publication
(10) Pub. No.: US 2013/0325489 A1
(43) Pub. Date: Dec. 5, 2013

(54) SECURE COMMUNICATIONS AND WORKFLOW MANAGEMENT FOR HEALTHCARE PROFESSIONALS, INCLUDING HEALTHCARE PROFESSIONAL AVAILABILITY STATUS

(71) Applicants: John M. Abrahams, Scarsdale, NY (US); David Crane, Centerport, NY (US)

(72) Inventors: John M. Abrahams, Scarsdale, NY (US); David Crane, Centerport, NY (US)

(73) Assignee: MOBILE HEALTH ONE, INC., Hauppauge, NY (US)

(21) Appl. No.: 13/530,571

(22) Filed: Jun. 22, 2012

Related U.S. Application Data
(60) Provisional application No. 61/655,649, filed on Jun. 5, 2012.

(51) Int. Cl. G06Q 50/22

(52) U.S. Cl. 705/2

(57) ABSTRACT

A system for managing healthcare-related communications includes a computer network and a server system comprising a portal that is accessible through the computer network. The server system includes a healthcare professional profile subsystem that is operable to perform operations including the following: receive input through the portal from a first computing device, wherein the input indicates an availability status for a first healthcare professional; store the availability status as part of a profile for the first healthcare professional; and in response to receiving a request through the portal from a second healthcare professional, provide for viewing by the second healthcare professional a listing of one or more healthcare professionals, wherein the listing includes the name and availability status of the first healthcare professional.

### CROSS-REFERENCE TO RELATED APPLICATION(S)

This application claims the benefit of priority of U.S. Provisional Patent Application No. 61/655,649, filed on Jun. 5, 2012, the contents of which are incorporated by reference.

### TECHNICAL FIELD

This disclosure relates to facilitating workflow management for healthcare professionals (HCPs) and enabling them to communicate, collaborate and share information, such as data, documents and images, with one another in a secure manner.

### BACKGROUND

Time is often of the essence when physicians and other healthcare professionals need to communicate with one another. For example, reducing delays when one physician needs to contact another can be critical to patient care. Workflow management among healthcare professionals, however, sometimes encounters various obstacles that make it difficult for healthcare professionals to communicate effectively. In particular, contacting colleagues by traditional phone and pager techniques often can be inefficient, and patient privacy laws may be limit or prevent the use of standard text and email communications regarding patient-related information. Thus, a wide range of issues can arise when a physician or other healthcare professional desires to contact another healthcare professional. For example, calling physicians may be uncertain whether their voice-mail, email or text message was received, or what time the message was received. Furthermore, it may be difficult for a primary care physician or other healthcare professional to find a referral or consultant in a particular medical specialty. At other times, it may be difficult for the primary healthcare professional seeking a referral to locate the telephone number or other contact information for a particular specialist. In some cases, such as emergency or urgent situations where a patient needs prompt attention by a physician in a particular specialty, it may be difficult for the primary care physician or other healthcare professional to identify which physicians in the required specialty are on-call or otherwise available.

Another concern relating to communications by healthcare professional arises because many healthcare professionals, including physicians, use email or text messaging to communicate with one another about patients. Such communications may not comply with relevant state or federal privacy laws such as the Health Insurance Portability and Accountability Act (HIPPA) legislation in the United States.

### SUMMARY

The present disclosure describes a network-based application for computing devices such as mobile phones, tablets, and other computing devices to facilitate workflow management for healthcare professionals and to facilitate secure communications, collaboration and sharing of information regarding patient care.

In one aspect, notifications about messages can be sent or received, for example, by text or email to or from the healthcare professional's personal computing device (e.g., mobile phone), or as a notification to a message inbox accessed through a secure Internet or other secure network portal. Messages and data containing the actual patient information, however, can be sent or retrieved only through the user's message inbox accessed through the secure Internet or other secure network portal. Some implementations allow each individual healthcare professional to select a delivery method for the message notifications.

In another aspect, healthcare professional can provide an indication of their current availability status. This information can be used so that other healthcare professionals easily can determine the availability status of a particular healthcare professional simply by accessing the portal. Healthcare availability schedules also can be integrated with other healthcare professional information to make it easier for healthcare professionals to determine which healthcare professional currently is on-call.

In some implementations, a healthcare professional system can be integrated, for example, with calendar and scheduling tools, external patient records databases, external databases storing patient-related images and documents, and/or electronic medical record (EMR) storage facilities.

According to yet another aspect, the web-based application facilitates creation of a physician-centric Internet or other computer network-based social network. According to some implementations, a physician who is a member of the social network can invite anyone, such as other healthcare professionals (including other physicians) and their patients, into the social network. On the other hand, non-physician members can invite non-physician healthcare professionals and their patients (but not other physicians) into the social network. A social networking subsystem determines whether a proposed invitation is permitted based, at least in part, on the professional position (e.g., physician or non-physician) of the inviting member and the professional position of the invited party.

In other implementations, as new healthcare professionals join the network, a tree-like structure is created automatically to track who invited each member into the network. Members can invite either physicians or non-physicians to join the network, regardless of whether the inviting member herself is a physician or non-physician. However, the extent to which a particular member can view information about other members in the social network depends on whether or not the particular member is a physician. In a particular implementation, a particular member can view information about other members in the social network that are located downstream in the tree structure. This applies regardless of whether or not the particular member is a physician. On the other hand, only physicians can view all upstream members in the network. In contrast, a non-physician member can view only a single upstream member in the tree structure (i.e., the member who invited the non-physician into the network). The systems and methods can thus help better protect physicians from being contacted by other healthcare physicians without their permission.

In a further aspect, referrals/consultations between physician or other healthcare professional members in the network are tracked automatically. The tracking system can be based, for example, on requests for consultations that flow through the web portal, cloud technology or a mobile device application. In some implementations, members also can add their favorite referrals to be included in the lists of frequent referrals that are tracked. A referral tracking subsystem can produce, for example, a distribution of each member's frequent referrals, as well as the most frequent referrals overall, for example, by geographic location (e.g., by zip code), by hospital and/or by specialty and sub-specialty. This information can be provided to, and displayed on, a physician's computing device in response to a search query. Thus, by accessing the portal, a physician or other healthcare professional can review a list of referrals made by other members individually or collectively as a group (e.g., by geographic location (e.g., by zip code), by hospital and/or by specialty and sub-specialty). These referral tracking features can help facilitate identifying and contacting referrals among members.

Systems, methods and media that incorporate one or more of the foregoing aspects, as well as other aspects, are described in greater detail below. Some implementations may incorporate features relating to more than one aspect.

Some implementations include one or more of the following advantages. For example, the systems and methods described in this disclosure can help improve workflow management for physicians and other healthcare professionals. The techniques can help maintain required privacy of patient data and other information, while at the same time allowing healthcare professionals to communicate effectively using their personal computing devices, such as mobile phones, tablets, etc. Although the systems and methods are, in some respects, physician-centric, they may still integrate the entire healthcare professional team, and in some cases also the patient, and thus expedite medical decisions and improve care.

Other aspects, features and advantages will be apparent from the following detailed description and the accompanying drawings.

### BRIEF DESCRIPTION OF THE DRAWINGS

FIG. 1 is an example of a system that incorporates aspects of the invention.

FIG. 2 is an example of a log-in page accessible through a web-based portal.

FIG. 3 is an example of a web page accessible through the portal.

FIG. 4 is an example of another web page accessible through the portal.

FIG. 5 is a further example of web page accessible through the portal.

FIG. 6 illustrates an example scenario of two healthcare professionals communicating through the web-based portal.

FIG. 7 illustrates additional details of a scenario involving physicians communicating through the web-based portal.

FIG. 8 illustrates an example of a tree structure for members in a physician-centric social network.

FIG. 9 illustrates an example of physician referral chain.

FIG. 10 illustrates an example of a network referral web page.

FIG. 11 illustrates an example of information that can be tracked by a referral tracking subsystem.

FIG. 12 illustrates an example of a server system.

FIG. 13 illustrates an example of a computing device.

### DETAILED DESCRIPTION

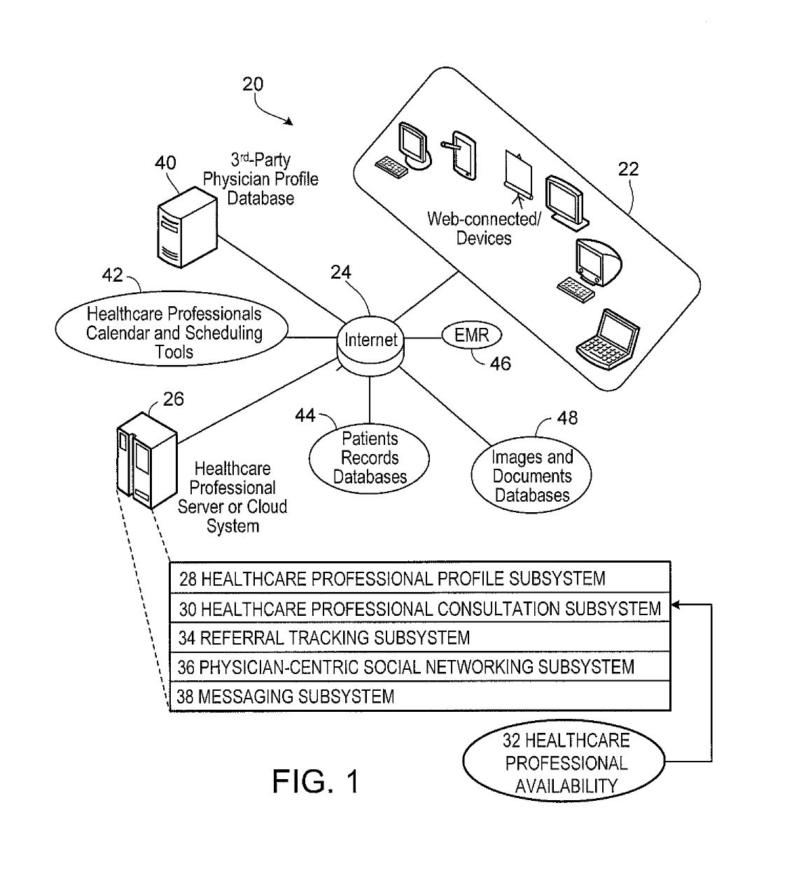

As shown in the example of FIG. 1, a network-based (e.g., Internet-based) HIPAA-compliant system 20 includes one or more personal computing devices 22 that provide connectivity to the Internet or other network 24. Each computing device can include a display screen and a user input interface (e.g., keyboard, mouse, touchscreen, etc.). Examples of the personal computing devices 22 include mobile phones, tablets, notebook computers, laptop computers, personal digital assistants (PDAs) and other personal computing devices including various handheld devices. Each personal computing device 22 can be a network-enabled device that can execute application software such as an Internet browser to provide access to the Internet.

Each personal computing device 22 may be associated with a particular healthcare professional and can be used by the healthcare professional to register with a system 26 and to interact with other healthcare professionals through the system. In some implementations, a software program may be installed on the computing device 22 to allow it to interact with a communications and workflow management application on the system 26.

In some implementations, the system 26 is part of a server system. In some cases, server system 26 may be part of a cloud-based, or hosted, computing system. Cloud-based, or hosted, computing generally involves executing applications via a web browser, and obtaining information for the applications from a remote server system or service and involves the delivery of computing as a service whereby shared resources, software, and information are provided to computers and other devices as a utility over a network such as the Internet. Thus, cloud computing can make use of a set of pooled computing resources and services delivered over the web. Cloud computing can provide advantages over traditional desktop software, such as the ability to access documents from various different computers and locations.

The system 26 can include, for example, one or more servers and associated databases and other storage media for storing computer-readable instructions for operating the system 26 and for implementing the communications and workflow management application described below, as well as for storing various types of information related to the healthcare professionals and their patients. As illustrated in FIG. 1, the system 26 can include one or more subsystems such as a healthcare professional profile subsystem 28, a healthcare professional consultation subsystem 30, a referral tracking subsystem 34, a physician-centric social networking subsystem 36 and a messaging subsystem 38. The healthcare professional consultation subsystem 30 or other subsystems may receive input from a physician on-call schedule 32. Some implementations of the system 26 may include fewer than all of the illustrated subsystems and, in some cases, may include additional or different subsystems. One or more of the subsystems 28, 30, 34, 36, 38 may be integrated within the same part of the system 26.

In some implementations, the system 26 can be integrated with other databases and software-based tools, such as a healthcare professional calendar and scheduling tool 42, a patient records database 44, electronic medical records (EMR) 46 and an images and documents database 48. The calendar and scheduling tool 42 can facilitate healthcare professionals setting their schedules and, in some cases, for accessing the schedule of another healthcare professional to determine the other healthcare professional's availability. The electronic medical records 46 may be stored, for example, at an office of a healthcare professional or at a hospital. Such records may include, for example, patient history and data, including lab results, test results and medical images. The database 48 may store images and documents related to patient care (e.g., MRI images, x-ray images, etc.). In some implementations, the system 26 also can communicate over the Internet or other network 24 with other third-party systems and databases, such as a third-party physician profile database 40, to access information about physicians or other healthcare professionals. Information obtained from such a third-party system can be stored in databases that are part of the system 26.

In one aspect, the user (i.e., healthcare professional) accesses a secure, web-based or cloud-based communication portal associated with the system 26, for example, through a computer's web browser or through an Internet-enabled mobile phone or other computing device 22.

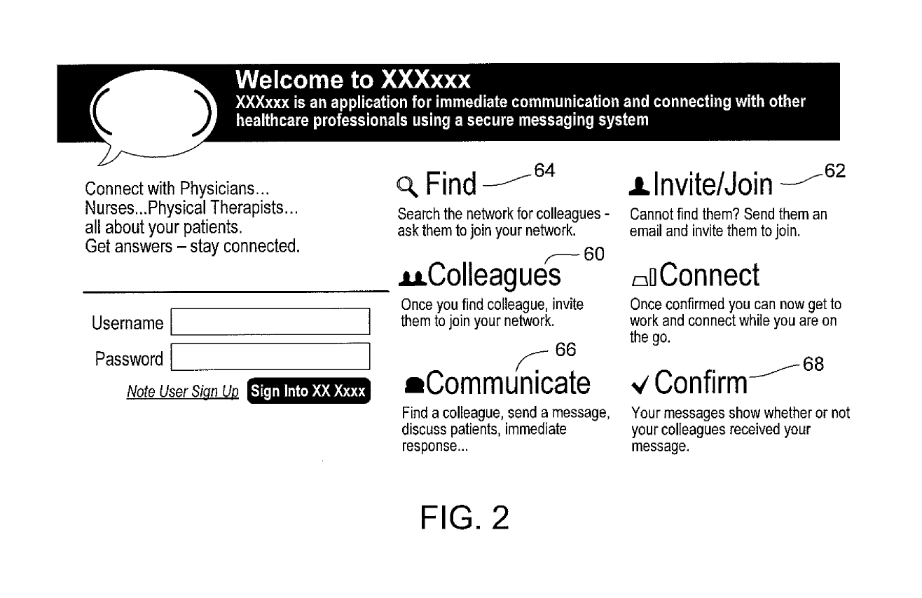

To register with the software application for healthcare professionals described below, the user accesses the web-based, communication portal. An example of the system's home page is illustrated in FIG. 2. In some implementations, the user clicks on a “Sign Up” link on the home page, and completes any required registration information (e.g., name, address, mobile phone, email or other contact information, etc.). Some implementations may include an authentication for new members. The user may be required to select a username name and password. In some implementations, certain registration information such as mobile phone and email can be designated as private or restricted so that it is not automatically shared with other healthcare professionals who are not granted permission to review the user's profile. More generally, in some implementations, the user is able to select the extent to which other members are able to access and view various fields in the user's profile. Thus, for example, the user may specify that some fields are public, private (i.e., only accessible to the user) or restricted (i.e., accessible only to other members or a group of members specified by the user). In some implementations, “public” is the default setting such that the information in the fields will be accessible by other members of the network unless the user changes the setting to “private” or “restricted.”

To log in to the system, the user accesses the system's 26 home page, enters his user name and password, and clicks a “Sign In” button. The user's profile can be based, in part, for example, on the information entered at the time of registration. The profile subsystem 28 can automatically load this information into a database that stores the user's profile.

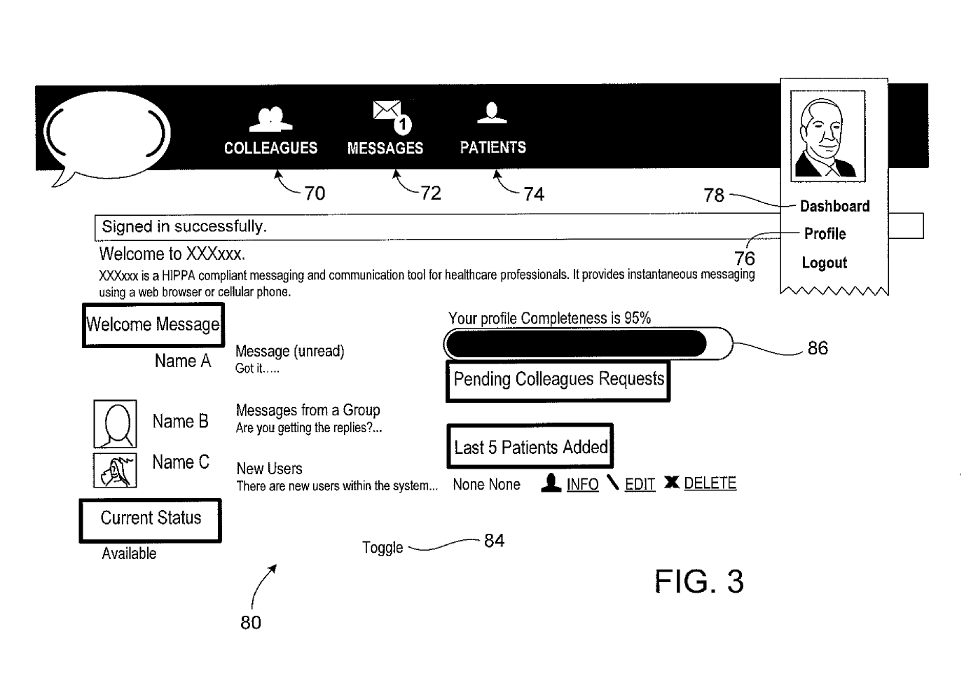

In the illustrated example, after the user signs into the system (e.g., after the user enters his username and password), a dashboard 80 is displayed on the user's personal computing device 22 (see FIG. 3). The dashboard 80 can allow the user to perform various activities within the same web-based interface. For example, in the illustrated example, the user can enter and edit a personal healthcare profile, locate colleagues, invite colleagues to join a physician-centric social network, communicate with colleagues, and manage patient and other healthcare-related messages. In the illustrated example, the dashboard also displays an indication of the healthcare professional's profile completeness, in other words, how much of the healthcare professional's profile has been completed as a percent-progress icon 86.

From the dashboard 80, the user can access a profile page that allows him to enter, edit or update personal information about his professional profile by clicking, for example, on a “Profile” tab 76. The healthcare professional's profile helps other members using the application running on the system 26 determine whether they wish to refer certain patients or otherwise interact with the particular user on a professional basis. The user can supplement or edit the information at different times so as to update his profile.

Various information can be provided as part of the healthcare professional's profile, including, for example, account information (e.g., name and email address, photo of the user) and contact information (address, office telephone and fax numbers, cell phone number). The profile subsystem 28 also can provide a field for the user to enter his position (e.g., assistant, administrator, healthcare provider (e.g., physician, chiropractor, etc.) or healthcare support (e.g., nurse, social worker, physical therapist, etc.). Options for completing some of the fields can be provided, for example, through drop-down menus. Some implementations include various groupings of healthcare professionals such as the following: Profile 1 (assistant to a healthcare provider), Profile 2 (hospital administrator), Profile 3 (physician, chiropractor, podiatrist, osteopath, oral surgeon), and Profile 4 (nurse, nurse manager, physician assistant, surgical assistant, certified registered nurse anesthetist, physical therapist, occupational therapist, dietician, social worker, certified nursing assistant, medical assistant). Additional fields for entering profile information are displayed on the user's computing device 22 depending on the professional position identified by the user. Thus, the profile subsystem 28 can prompt the user to enter or select information for additional fields regarding the user's professional background, experience and role. For example, healthcare professionals such as physicians may be requested to provide information in their profiles such as college, medical school, degree, residency (hospital and specialty), fellowship (hospital and specialty), affiliated hospitals, and insurance plans accepted. Some of the fields may have associated drop-down menus or other features that facilitate selection of the appropriate information. Other types of healthcare professionals may be requested to provide additional or different information.

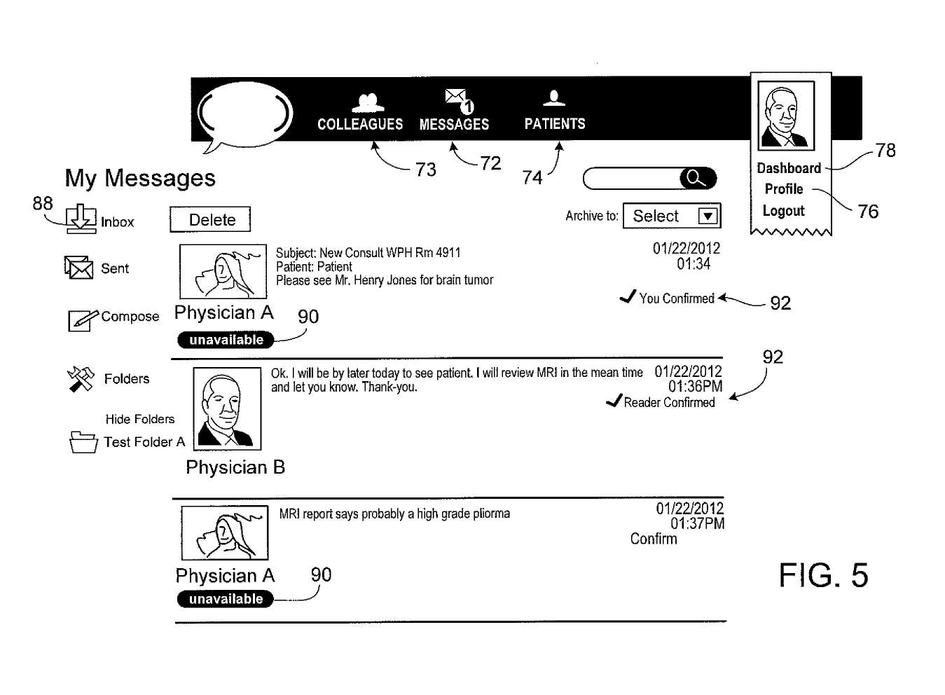

The profile page also can allow the user to select a notification method for receiving new messages designating that user as a recipient. A user may select to have notifications sent to his computing device 22, for example, via email or text messages. Alternatively, or in addition, a user may select an option for notifications to be received in an inbox 88 that can be accessed from a messages page available only through the portal (see FIG. 5 discussed below).

The illustrated dashboard 80 also can display the healthcare professional's (e.g., physician's) recent messages, a list of colleagues who recently have joined the healthcare professional's social network using the application, pending requests sent to other colleagues, pending requests other colleagues sent to the healthcare professional, a list of the colleagues most commonly contacted by the logged-in user and a list of the colleagues most commonly contacted by all users. The user can return to the dashboard 80 from other pages in the application by clicking a “Dashboard” tab 78.

The dashboard allows the user to select or change his current availability status. For example, a toggle switch or drop-down menu 84 can provide multiple choices from which the physician can select whether he currently is available or unavailable. In some implementations, other options (e.g., in surgery, in procedure, on vacation) also may be available to indicate the physician's current availability status. As indicated above, calendar and scheduling tools 42 and/or a healthcare professional availability schedule 32 can be integrated with the system.

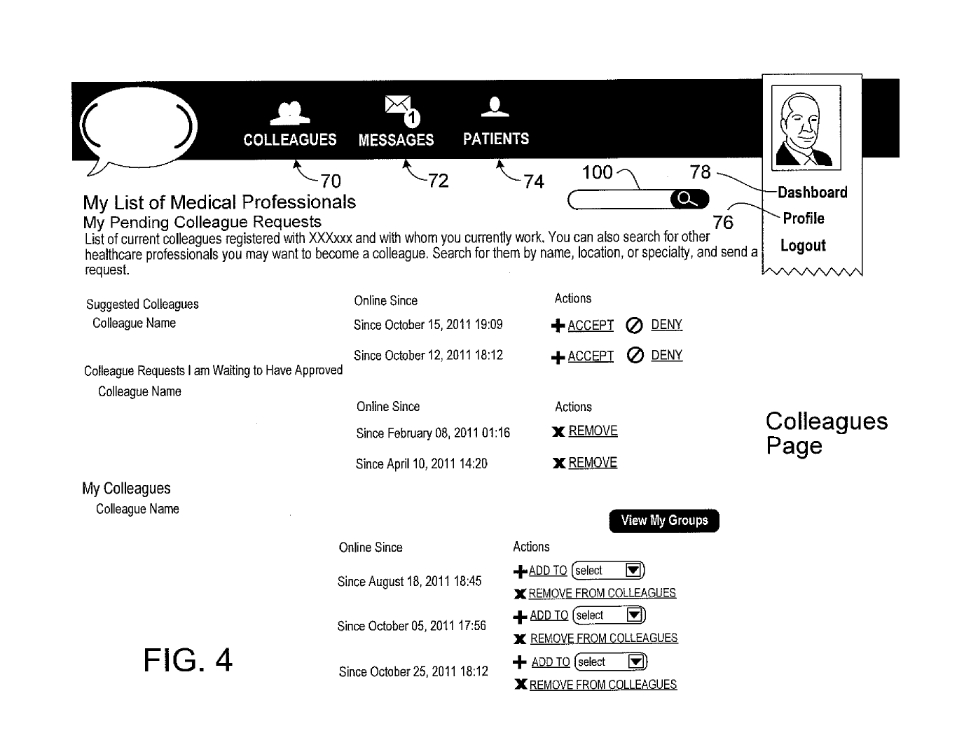

In some implementations, a “Colleagues” page (see FIG. 4) can be accessed by clicking on a “Colleagues” tab 70. A search function is available by entering one or more terms into a search box 100 to search the entire user database of profile information (e.g., name, address, specialty information, insurance plans, etc.). Various types of searches may be available, such as a simple search in one only a single search term is used to search all fields, or an advanced search which allows searching of multiple fields with multiple search terms. In some implementations, users within the same hospital network are automatically added to each other's network. Colleagues can be listed, for example, by name, specialty, primary hospital, status (e.g., available or unavailable). In some implementations, when a user selects a particular colleague to whom to send a message, the application defaults to composing a message with the receiving colleague's email (or other contact information) automatically filled in. Actions also can be applied to groups of members in the network (e.g., create/add/delete a group name; add a user to multiple groups; send a message to a group based on the group name).

In the illustrated example, colleague requests also are displayed. This section can include colleague requests that the user is waiting to have approved. Once the request is made from the current user to another colleague, a notification comes through to the user's inbox 88 (FIG. 5) or by email or text message to the recipient's computing device 22, depending on the recipient's profile settings stored in the profile subsystem 28. Other users requesting to become the colleague of the logged-in user are listed as a pending request under a different heading (e.g., “Colleague Requests I Need to Approve”). Colleagues already in the individual user's network can be listed under the heading as “My Colleagues.” As noted above, users that list the same primary hospital as one another can be added by the application automatically to each other's network of “My Colleagues.”

A physician also can enter and review patient information to be stored by the system, for example, by clicking a “Patients” tab 74. The user can create patient profiles with data fields such as name, address, date of birth, email address, cell phone number, diagnosis, medical history, allergies and another notes or patient information. The patient information can be included, for example, in a secure text or email message to another member of the network or can be copied to the member's assistant. Alternatively, or in addition, the message can be populated with one or more attachments (e.g., medical images or lab/test results) or can include a link to an external source (e.g., EMR 46).

The system 26 provides for HIPPA-compliant messaging for HCPs and facilitates secure communications using, for example, one or more of email, web-based applications, text messages or other forms of electronic communications. In some implementations, the system 26 uses secure sockets layer (SSL) encryption, including 1024-bit public key encryption.

Messages to and from the particular physician or other healthcare professional can be composed, sent and reviewed, for example, by clicking on a “Messages” tab 72, which causes a messages page to be displayed (see FIG. 5). In the illustrated example, the messages page includes an “inbox” icon for reviewing new incoming messages, a “sent” icon for reviewing messages sent by the user, and a “compose” icon for creating and sending new messages. Some of the fields in a new message can be auto-filled by the system. If desired, the user can attach, for example, a patient report or image to the message, which then can be sent together with the message to the designated recipient(s). Once the message is sent, a notification is sent to the recipient's email or text address for her computing device 22 or to her inbox 88, alerting the recipient that she has received a message in her inbox 88 available through the portal (FIG. 5). On the other hand, the message itself and any attachments can be retrieved only through the user's inbox 88 through the secure system 26. Thus, the email and text messages simply serve as notifications of a new message to the user. Private health (i.e., patient) information, however, is not communicated through text or email communications to the user's personal computing device 22. Instead, such information is transferred through the web-based portal. To access and read the actual message and any attachments, the user needs to log into the secure web-based portal.

Messages can be stored in one or more electronic folders. When a user views a message, the system 26 sends a date and time stamp to the sender confirming that the message has been viewed. Until that event occurs, the system 26 generates a date and time stamp for the message with the time it was sent, but records that receipt of the message has not yet been confirmed. In some implementations, associated with the text of each displayed message can be an indication 90 of author's status (e.g., available, unavailable, in surgery, on vacation, etc.) obtained from the profile subsystem 28 as well as indication 92 of whether or not the recipient of the message read the message or replied to the message (see FIG. 5).

As noted above, a member of the network can indicate via the dashboard whether he currently is available or unavailable, and the system stores the current status of the physician. Preferably, when a user sends a message, he is notified by a notice in his inbox if the recipient's status indicates he is unavailable. The message itself, however, is still sent to the recipient's inbox 88.

To communicate, for example, with another healthcare professional in the physician-centric social network available through the portal (i.e., through the application made available by the system 26), a physician can click, for example, on one of the “Colleagues” icons 60, 70 and use the search box 100 to search for colleagues to build a social network. Anyone appearing in the displayed list already is registered as a member in the system 26. The user can request to be associated with a particular member such that they are part of the user's social network. If the other member agrees and accepts the invitation by responding in the affirmative, then the other member is stored as part of the user's on-line social network; the physician and the colleague can communicate with one another through the secure system 26.

If a user cannot locate a particular colleague, he can click on an “Invite/Join” icon 62 (FIG. 3) and invite a new colleague using his or her email or text address. The “Find” icon 64 can be used to search for a colleague, for example, by name, location, specialty, degree, or insurance plans accepted.

Once a user has accepted a colleague's request or has had a colleague accept the user's request to be associated with one another in the social network, the user and the other person can communicate with each other directly and immediately by sending a message through the secure system 26. To communicate with a colleague, the user can click on the “Communicate” icon 66. Members can exchange reports (e.g., medical reports, medical images, or patient test results) securely through the system 26, for example, as attachments to a message or through links to an external data source (e.g., images and documents database 48). As an example, once new information about a patient becomes available, a primary care physician can instantly share the information with a colleague by accessing the application provided by the system 26.

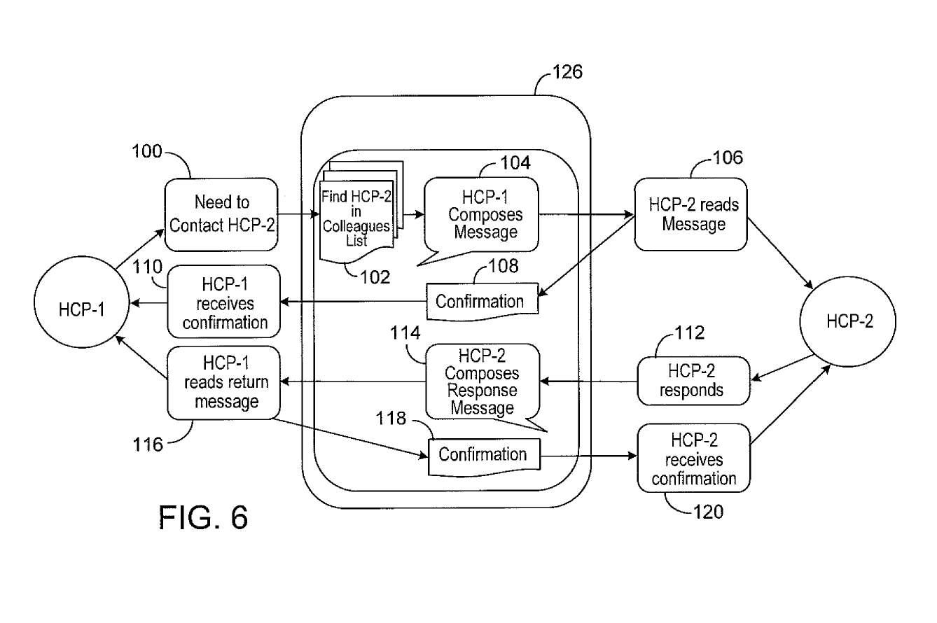

An example of how various messages can flow from one healthcare professional (HCP-1) to a second healthcare professional (HCP-2) using the application provided by the system 26 is illustrated in FIG. 6. In this example, healthcare professional HCP-1 decides that she needs to contact a colleague for a consultation and accesses the web-based portal and logs into application provided by the system 26 (block 100). Healthcare professional HCP-1 may use one of the “Colleagues” icons 60, 70 to initiate a search to locate contact information for a particular colleague or to find a colleague with particular credentials and/or medical experience (block 102). Healthcare professional HCP-1 can then compose a message, with or without an attachment, to be sent to healthcare professional HCP-2 (block 104). The messaging subsystem 38 then posts the message in the inbox 88 of healthcare professional HCP-2 and also sends a notification alerting healthcare professional HCP-2 of the new message in the inbox. As noted above, a user can have the option to see notifications about incoming messages either as a text message or as an email reminder sent to her computing device 22 or to her inbox 88 available through the portal. The messaging subsystem 38 can post the message substantially in real-time. To retrieve the message, healthcare professional HCP-2 accesses her inbox 88 available through the portal and reads the message and any attachments (block 106). The messaging subsystem 38 can send a confirmation message to healthcare professional HCP-1 to indicate that her colleague received and read the message (block 108). Healthcare professional HCP-1 then receives the confirmation message as a date and time next to the sent message within their application inbox (block 110). Alternatively, or in addition, a reminder message or notification can be sent to HCP-1.

If healthcare professional HCP-2 subsequently decides to respond to the message from healthcare professional HCP-1 (block 112), she can compose a message to be sent to healthcare professional HCP-1 (block 114). The messaging subsystem 38 then posts the response message in the inbox 88 of healthcare professional HCP-1 and also sends a notification alerting healthcare professional HCP-1 of the new response message in the inbox. As already noted, a user can have the option to see notifications about incoming messages either as a text message or as an email reminder sent to her computing device 22 or to her inbox 88 available through the portal. The messaging subsystem 38 can post the reply message substantially in real-time. To retrieve the message, healthcare professional HCP-1 accesses her inbox 88 available through the portal and reads the message and any attachments (block 116). The messaging subsystem 38 can send a confirmation message to healthcare professional HCP-2 to indicate that her colleague received and read the reply message (block 118). Healthcare professional HCP-2 then receives the confirmation message as a date and time next to the sent message within their application inbox (block 120). Alternatively, or in addition, a reminder message or a notification can be sent to HCP-1.

In the illustrated example, the messaging subsystem 38 handles and processes the various incoming and outgoing messages. As apparent from the foregoing example, healthcare professionals can contact and communicate with one another from their office, hospital, home or other location using a mobile phone or computing device to access the web-based portal.

In some implementation, the messaging subsystem 38 stores a record of the communications and enables a user to keep correspondence organized. The messaging subsystem 38 allows a user to maintain and store professional messages separately from the user's personal life. For example, the user can print or delete messages or save them in folders and subfolders stored by the messaging subsystem 38.

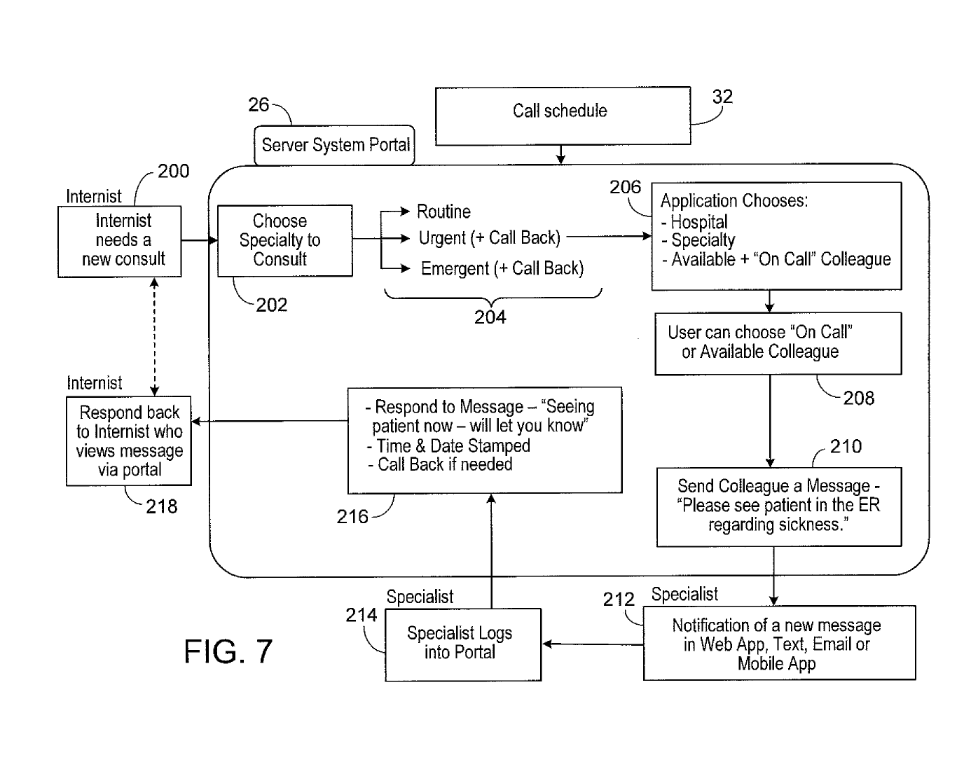

FIG. 7 illustrates another example in which a first physician (e.g., an internist) wishes to obtain the assistance or to consult a second physician who is a specialist in a particular medical field (e.g., neurosurgery). In this example, it is assumed that the first physician needs to consult with the second physician regarding a patient who is in the emergency room, but the first physician is not sure which physicians in the particular specialty might currently be available to visit the patient. This example illustrates how various subsystems, such as the profile subsystem 28, the consultation subsystem 30 and the messaging subsystem 38, can cooperate as part of the integrated system 26 to facilitate workflow management in healthcare.

When the internist decides that she wants to consult with a specialist (block 200), the internist uses her computing device (e.g., mobile phone) 22 to access the web-based communication portal made available by the system 26. After accessing the portal and logging in, the internist uses the portal's search features to search for a physician in the desired specialty (e.g., neurosurgery) (block 202). For example, the internist can locate the specialty within the “Colleagues” section of the portal. The application retrieves information from the appropriate database(s) associated with the system 26 and displays the information on the internist's computing device 22. The information can include, for example, an indication of which neurosurgeon currently is on-call. This information can be obtained by the consultation subsystem 30 from a database 32 or other memory that stores the physicians' on-call schedules. The on-call schedules can be uploaded to the system 26 in advance, for example, by a hospital administrator or can be accessed by integration with an external data source. This can be performed, for example, once or month just prior to the beginning of a new month. In some implementations, all physicians in the specified specialty (i.e., neurosurgery) who are on the staff of the same hospital as the internist are listed in the information retrieved the consultation subsystem 30 for display on the internist's computing device 22. In addition, the consultation subsystem 30 can retrieve information indicating whether each listed physician is currently available or unavailable. This information can be retrieved from a database associated with the profile subsystem 28, which, as discussed above, allows a physician to indicate as part of his profile whether or not he currently is available.

In some implementations, the internist can choose to browse through the entire displayed list of colleagues who are members of the neurosurgery department or division in the same hospital as the internist, browse through the list of neurosurgery colleagues whose status indicates they currently are available, or browse to the particular neurosurgeon who currently is on-call (block 206). By interacting with the application through his computing device 22, the internist can select a particular neurosurgeon (e.g., the physician who is on-call or another available physician) (block 208) and can indicate whether the consultation is needed, for example, on an emergency basis, an urgent basis, or a routine basis (block 204). A drop-down menu can be used, for example, to allow the physician to select one of these options. The internist also can draft a message (e.g., a consult request), which the messaging subsystem 38 then sends to the selected neurosurgeon (block 210). For example, the message might read: “Please see patient Mr. X is the emergency room regarding illness Y.” The order of the foregoing steps may vary in some implementations. As explained previously, the messaging subsystem 38 posts the message to the neurosurgeon's inbox 88 and sends a notification about the message to the neurosurgeon (block 212). Depending on the neurosurgeon's profile stored by the profile subsystem 28, the notification may be sent to the neurosurgeon's computing device 22, by email, text message or some other application, and/or the notification may be sent to the neurosurgeon's inbox 88. Preferably, if the internist selected to designate the need for a consultation either as “urgent” or as an “emergency,” the messaging subsystem 38 sends the message, but also causes a pop-up message to appear on the internist's computing device 22 suggesting that the internist also contact the neurosurgeon directly by telephone.

Upon receiving the notification of the new message, the neurosurgeon uses his computing device 22 to log into the portal through the system 26 (block 214), where he can read and respond to the internist's message (block 216). For example, the neurosurgeon might respond as follows: “Seeing patient now—will let you know the outcome.” The messaging subsystem 38 sends the neurosurgeon's reply message to the internist's inbox 88 and also forwards a notification, for example, by email or text, to the internist's computing device 22. The internist then can retrieve and read the reply message through the portal. The messaging subsystem 38 can provide time and date stamps for each message and, as explained above, can send a confirmation to the sender's inbox 88 acknowledging that the recipient received and read the message.

Use of the portal can thus facilitate communications between physicians and can help ensure that private information concerning patients is accessible and can be retrieved only by through the portal. The system can facilitate identifying and contacting a colleague in the same or another specialty. Determining which physicians are on-call or currently available can be accomplished in a manner that can reduce or avoid delays inherent in some existing systems (e.g., calling the specialist's office, which then must page the specialist).

In some implementations, the system 26 allows the conversation thread (e.g., between two physicians) to be saved within the application, deleted, printed, converted to a pdf or other file, or exported to an electronic medical record.

As noted above, once a user registers with the application through the portal on the system 26, the user can establish or join an on-line social network that is accessible through the system portal. For example, in some implementations, the user's profile is converted to a social networking page that is available through the portal to other colleagues who are part of the user's social network. The user also can join pre-existing on-line hospital social networks. For instance, if a healthcare professional is on staff at a particular hospital (XYZ Medical Center), the system automatically lists (by default) the healthcare professional as a member of the hospital's network if he chooses that hospital in his profile. Thus, the healthcare professional instantly becomes a colleague with all registered users of XYZ Medical Center.

In general, each user can decide which other healthcare professionals will be permitted to join the user's on-line social network. Thus, a registered user can invite other healthcare professionals as colleagues to join the user's on-line social network. Likewise, the user can accept or decline to accept another healthcare professional's becoming a colleague in the user's on-line social network. The social networking subsystem 36 stores information about each social network. The social networking subsystem 36 interacts with the profile subsystem 28 so that information from the latter can be incorporated into the former.

An aspect of the social networking system relates to a physician-centric social network that allows non-physician healthcare professionals to join the network, but with different permissions and access rights than those of physicians. In some implementations, permissions and access rights depend on the individual's professional role as well as how they were invited into the system.

For example, according to some implementations, a physician who is a member of the social network can invite anyone such as other healthcare professionals (including other physicians) and their patients, into the social network. On the other hand, non-physician members can invite non-physician healthcare professionals and their patients (but not other physicians) into the social network. The social networking subsystem 36 determines whether a proposed invitation is permitted based on the position (e.g., physician or non-physician) of the inviting member and the position of the invited party.

As discussed above, each member of the social network can select the extent to which other members are able to access and view various fields in the user's profile. Thus, in some implementations, a particular member may specify whether each field is public, private (i.e., only accessible to the user) or restricted (i.e., accessible only to other members or a group of members specified by the user). For example, a particular member may choose to make his mobile cell number or his email address available only to specified individual members or to a specified group of members (e.g., members who belong to the same hospital as the particular member). Some implementations allow users to create their own user-defined groups. In some cases, such groups or user types may be pre-defined by the system for selection by the user.

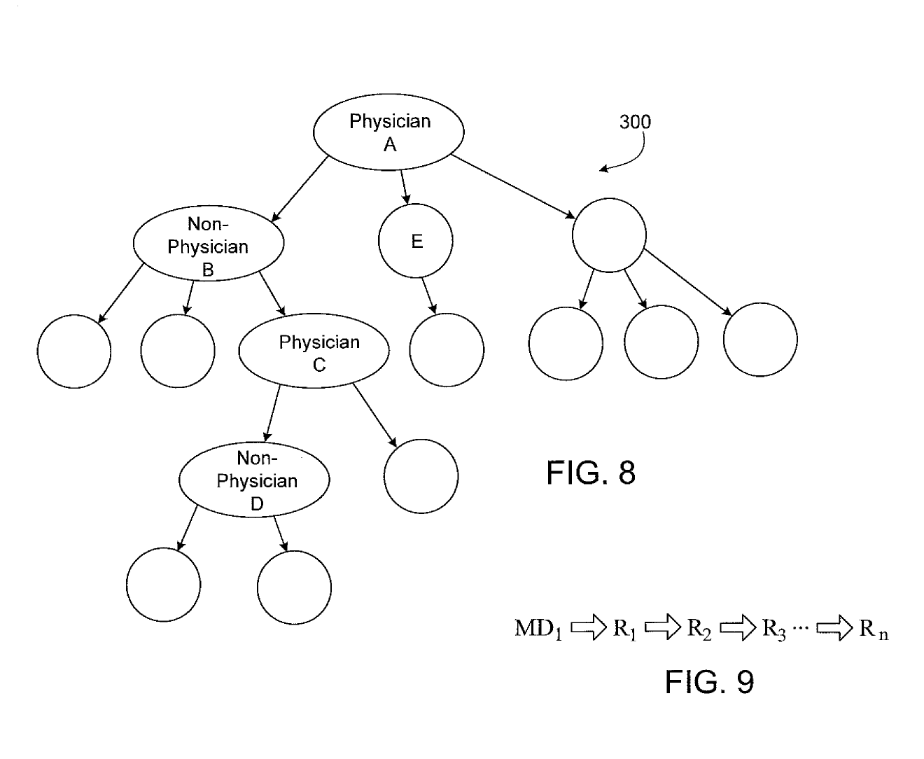

In some implementations, permissions to invite other members into the network and access to information about other members in the network is controlled in a different manner. For example, as new contacts join the network, a tree-like structure 300 can be created automatically by the social networking subsystem 36 to track who invited each member into the social network (FIG. 8). In some implementations, once registered, all members can invite either physicians or non-physicians to join the network, regardless of whether the member himself is a physician or non-physician. In the illustrated example, an arrow points from each member of the social network who extended the offer to join the network to another healthcare professional who accepted the invitation to join the social network. Thus, in FIG. 8, physician A invited non-physician B who then invited physician C who, in turn, invited non-physician D.

In the illustrated implementation of FIG. 8, the extent to which a particular member can view information about other members in the social network depends on whether or not the particular member is a physician. Thus, in some implementations, all members can view information about other members who are located downstream in the tree structure of the social network. This applies regardless of whether or not the member is a physician. For example, in the example of FIG. 8 in which physician A invited non-physician B who then invited physician C who invited non-physician D, then A can view B, C and D in the network, B can view C and D, and C can view D.

On the other hand, in the illustrated implementation of FIG. 8, only physicians can view all upstream members in the social network. In the foregoing example, physician C can view A and B. In contrast, a non-physician member can view only a single upstream member in the social network—i.e., the particular member who invited the non-physician member to join the network (assuming the non-physician member joined the network by accepting that invitation). In the foregoing example, non-physician D can only view C, but not A and B. Also, whereas physician members in the social network can view all other contacts regardless of where they are positioned in the tree structure, non-physician members can only view only members who are downstream in the tree structure and the single immediately preceding upstream member. Thus, in the example of FIG. 8, physician member C can view information about members E, F and G. In contrast, non-physician members B and D cannot view information about members E, F or G.

One advantage of the foregoing feature is that it can provide better control as to which members can view and contact other members within the social network and can better protect physicians from being contacted without their permission by other healthcare professionals in the network, while at the same time allowing these other healthcare professionals to be included in the system.

Some implementations allow a member of a social network to communicate through the web-based portal with an individual who has not registered to become a member of the social network. Assuming, for example, that the member knows the email address of the non-member with whom he wishes to communicate, the member can initiate communications by sending a message to the non-member in the same manner as he would if he were communicating with another member. In response, the profile subsystem 28 automatically creates a profile and temporary system access security credentials (such as user ID and password) for the non-member. In some cases, the profile may include only the non-member's email address and possibly an associated name. However, in other cases, the profile subsystem 28 may populate additional fields in the temporary profile for the non-member automatically by obtaining information, for example, from the third-party physician database 40 or from some other source. The messaging subsystem 38 stores the message from the member and sends a notification to the non-member as described above (e.g., by email). Upon receiving the notification, the non-member is permitted to access the message through the web-based portal using their temporary security credential as described above just as a member would be permitted to do. Furthermore, when the non-member reads the message the system will send a notification that the message was read containing the date and time it was read to the sender of the message. In addition, the non-member may be permitted to reply to the message using the messaging subsystem 38, and the reply message may be time-stamped by, and stored in, the system 26 as well.

Although the non-member is permitted to access the message and may be permitted to reply to it as well, the non-member is restricted in some respects regarding use of the system 26. In particular, the non-member may not be able to communicate with members of the social network proactively, but may be limited to responding to a message initiated by an existing member. More generally, the non-member may be permitted to use various tools of the system, such as performing searches, creating a social network profile and creating network lists. However, unless the non-member registers and becomes a member of the social network, he would not be permitted to cause the system 26 to send invitations to join his social network or to initiate communications through the system, other than those noted above.

In the event the non-member subsequently decides to join the social network, he will find that the system has already pre-populated at least some of the fields in his personal profile, thereby facilitating completing his user profile and joining the social network.

The referral tracking subsystem 34 tracks referrals (sometimes called ‘consultations’) made by one healthcare professional member of the social network to another member. The tracking can be based, for example, on requests for consultations that flow through the portal of the system 26 as described above. For example, as explained above, a first physician can specify a particular specialist to consult by choosing the particular consult and sending patient information to the consulting colleague through the system 26. In some implementations, physicians also can add their favorite referrals to be included in the lists of frequent referrals created by the referral tracking subsystem 34.

In some implementations, the referral tracking subsystem 34 assigns a unique identification number to each referral and correlates each referral number to messages related to a particular patient and referral source. For example, every time a referral is made to another colleague, a frequency distribution can be allocated for that referral. For instance, FIG. 9 illustrates an example of a physician referral chain for a particular patient, in which MD₁ is the primary physician, who made a referral to R₁ (a physician in specialty 1), who then made a referral to R₂ (a physician in specialty 2), who made a referral to R₃ (a physician in sub-specialty 3). During the decision support for the particular patient, the referrals (R₁, R₂, R₃) may communicate with one another and with the primary physician (MD₁). In some implementations, the referral tracking subsystem 34 assigns each communication a frequency that is recorded with respect the primary physician (MD₁). Thus, the primary physician has a frequency of referrals with respect to himself as well as frequency of referrals in general.

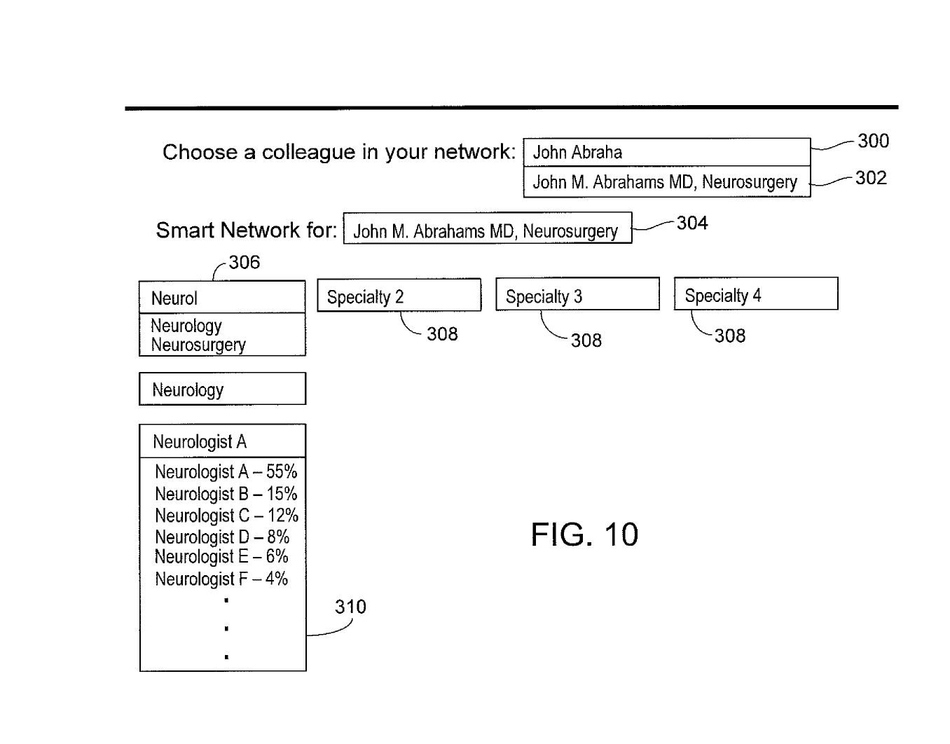

FIG. 10 illustrates an example of a referral network web page accessible through the portal which allows a physician, for example, to enter or select search terms for finding a specialist in a particular medical field. The user can search for a particular colleague whose referrals the user would like to review by typing the colleague's name (or the first few letters of the name) into a search field 300 or by searching for the colleague's name in a pull-down menu 302. The name of the colleague of interest then is selected from the list and the name automatically appears in box 304. Next, the user can search a particular specialty by typing the name of the specialty (e.g., neurology) into a search field or by searching one or more drop-down menus 308. This allows the user to review a list of referrals of the particular colleague (e.g., John M. Abrahams in the illustrated example) in the designated specialty. In this example, the names of the physicians in the particular specialty appear in a list 310 with an indication of the percentage of referrals made by the colleague of interest to each listed physician in the specialty. In the illustrated example, neurologist A received 55% of the referrals from the user's colleague, neurologist B received 15% of the referrals, etc. The user can select one of the listed physicians from the designated specialty and can, if desired, initiate a message to the selected physician regarding a patient referral through the portal as previously described.

In some cases, specialties can include sub-specialties as well. Additional fields can be provided for each sub-specialty. Sub-specialization fields can improve the accuracy of targeted referrals. For example, subspecialties under the category neurology may include “Epilepsy,” “Stroke,” “Peripheral Nerve,” etc. In some implementations, the list of referral names can depend on the physicians who are on staff at the same hospital as the user. For example, a separate field or drop-down menu can be provided to allow selection of “outpatient” or “inpatient.” If the user selects “inpatient,” the displayed list of referrals would include all referrals that are on staff at the same hospital as the user. If the user selects “outpatient,” the displayed list of referrals would include all referrals in the user's network based on a geographical constraint (e.g., within a radius of fifty miles).

In some implementations, once the user chooses a colleague (“John M. Abrahams” in the illustrated this example) and a first referral (“Neurologist A” in this example), the process can be repeated, if desired, by entering or selecting “Neurologist A” in fields 300 or 302, so that the referral network of Neurologist A can be searched. Thus, after identifying a particular referral (e.g., Neurologist A) in the designated specialty (e.g., neurology), the user can search the system for referrals of Neurologist A in a particular sub-specialty of neurology.

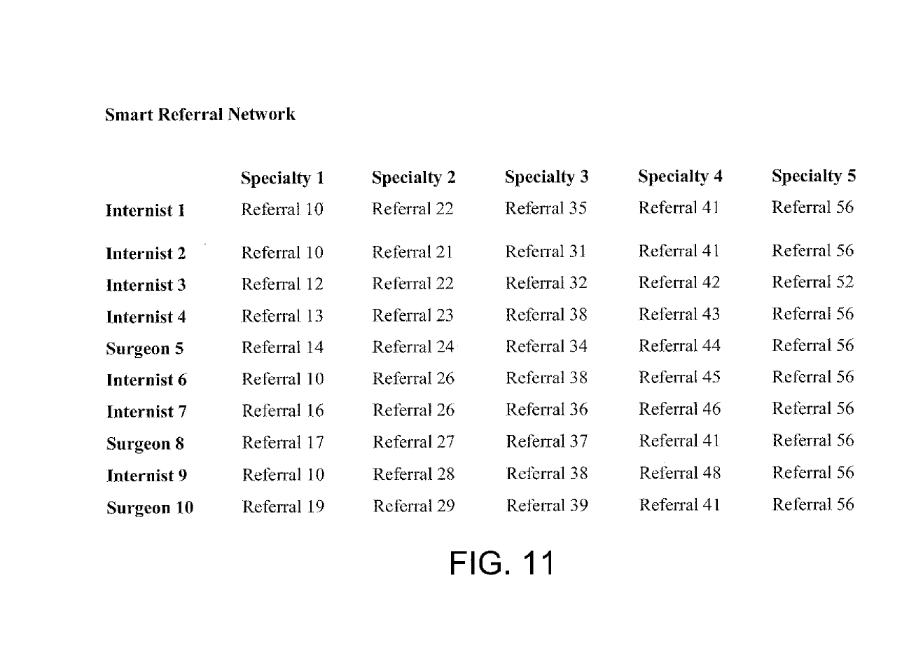

FIG. 11 illustrates an example of other information that, in some implementations, can be tracked by the referral tracking subsystem 34 and that can be displayed by the application on the physician's computing device 22 in response to a search request. In this example, various physicians listed in the far left-hand column have colleagues in various medical specialties or sub-specialties (identified at the top of the columns) with whom they prefer to work and to whom they make the majority (or all) of their referrals. The table in FIG. 11 lists the preferred specialist for each physician in the form “Referral xy,” where ‘x’ indicates the particular specialty or sub-specialty and ‘y’ indicates the particular physician in that specialty or sub-specialty. Typically, the information provided to and displayed on the computing device 22 of the physician seeking the consultation would include the actual name of the specialist. The primary care physician could then use the system 26 portal to communicate directly with the specialist.

The information from the referral tracking sub-system 34 may be provided and displayed in other formats as well. For example, in some implementations, the referral tracking subsystem 34 can produce a distribution of each physician's frequent referrals, as well as the most frequent referrals overall, for example, by geographic location (e.g., by zip code), by hospital and/or by specialty and sub-specialty. This information can be provided to a physician's computing device 22 in response to a search query entered into the computing device and transmitted to the server system 26.

By accessing the portal of the system 26 using a computing device (e.g., mobile phone), a physician can review a list of referrals made by other physicians individually or collectively as a group (e.g., by geographic location (e.g., by zip code), by hospital and/or by specialty and sub-specialty). For example, upon reviewing the information in the table of FIG. 11, a physician (e.g., an internist) seeking a consultation from a specialist in Specialty 1 can see that most of the listed internists (i.e., Internists 1, 2, 6 and 9) make referrals to the same physician (‘0’) in Specialty 1, whereas two other internists (i.e., Internists 3 and 4) make referrals to other physicians (‘2’ or ‘3’) in Specialty 1. Likewise, the physician seeking the consultation can see that the listed surgeons make referrals to other physicians (‘4,’ ‘7’ or ‘9’) in Specialty 1. The appropriate list is displayed on the physician's computing device 22 based on criteria selected by the physician from a drop-down menu or entered into search fields and can make it easier for a physician to determine which colleague to consult in a particular specialty, sub-specialty, location or hospital. The primary care physician may, therefore, be able identify a specialist needed for a consultation more easily and, in some cases, without having to ask colleagues as to which specialist they would recommend.

As a particular example, a primary physician, who is an ophthalmologist, may decide that she needs to consult with a macular degeneration specialist. However, the primary physician may not be familiar with the macular degeneration specialists in the hospital where she is on staff. On the other hand, she may have worked with a retinologist on the staff of the hospital. By accessing the portal, the primary physician can obtain information from the referral tracking subsystem 34 to identify which macular degeneration specialists the retinologist refers patients and to review the number of referrals (absolute or relative numbers such as by percentage) made to each specialist. Once the primary physician identifies a macular degeneration specialist with whom she wishes to consult, she can use the portal to send a message via the system 26 directly to the particular macular degeneration specialist with details about the consultation needed.

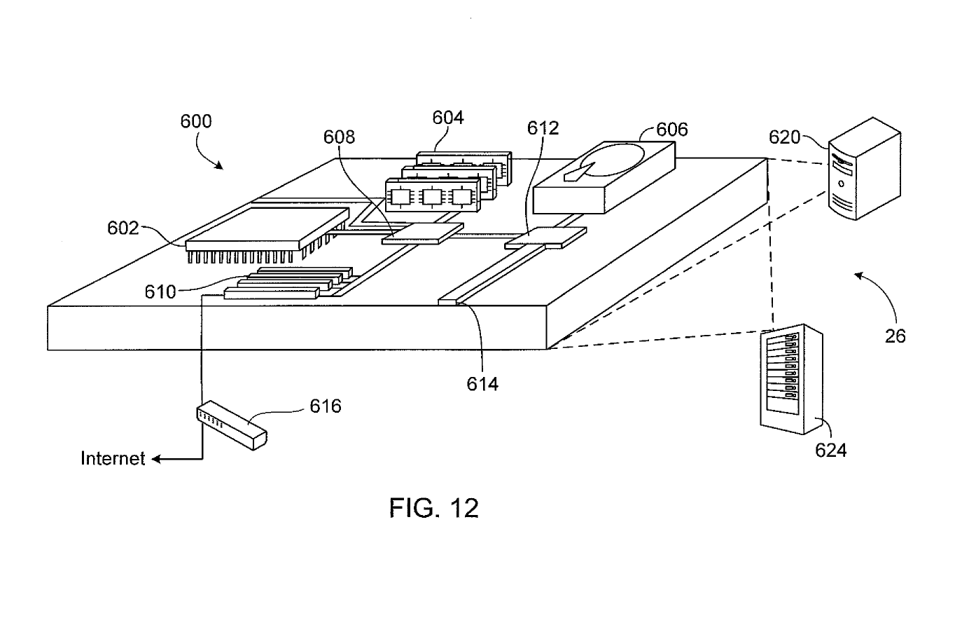

As noted above, the system 26 may be implemented, for example, as part of cloud-based computing system or other server system. Thus, as illustrated in FIG. 12, the system 26 may be implemented, for example, as a standard server 620 or as a group of multiple such servers. It may also be implemented as part of a rack server system 624.

In the illustrated example of FIG. 12, server system 26 includes a processor 602, memory 604, a storage device 606, a high-speed interface 608 connecting to memory 604 and high-speed expansion ports 610, and a low speed interface 612 connecting to low speed bus 614 and storage device 606. The components 602, 604, 606, 608, 610 and 612, are interconnected using various busses, and may be mounted on a common motherboard or in other manners as appropriate. The processor 602 can process instructions for execution within the server system, including instructions stored in the memory 604 or on the storage device 606 to display graphical information for a GUI on an external input/output device coupled to high speed interface 608. In other implementations, multiple processors and/or multiple buses may be used, as appropriate, along with multiple memories and types of memory.

The memory 604 stores information within the server system 26. In one implementation, the memory 604 is a volatile memory unit or units. In some implementations, the memory 604 is a non-volatile memory unit or units. The memory 604 may also be another form of computer-readable medium, such as a magnetic or optical disk. The storage device 606 is capable of providing mass storage for the server system 26. In one implementation, the storage device 606 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 604, the storage device 606, or memory on processor 602.

The high speed controller 608 manages bandwidth-intensive operations for the server system 26, while the low speed controller 612 manages lower bandwidth-intensive operations. Such allocation of functions is exemplary only. In one implementation, the high-speed controller 608 is coupled to memory 604 and to high-speed expansion ports 610, which may accept various expansion cards (not shown). In the illustrated implementation, low-speed controller 612 is coupled to storage device 606 and low-speed expansion port 614. The high-speed expansion port 610, which may include various communication ports, can be coupled to one or more input/output devices, including a networking device such as a switch or router 616, e.g., through a network adapter, which is coupled to the Internet or other network 24 (FIG. 1).

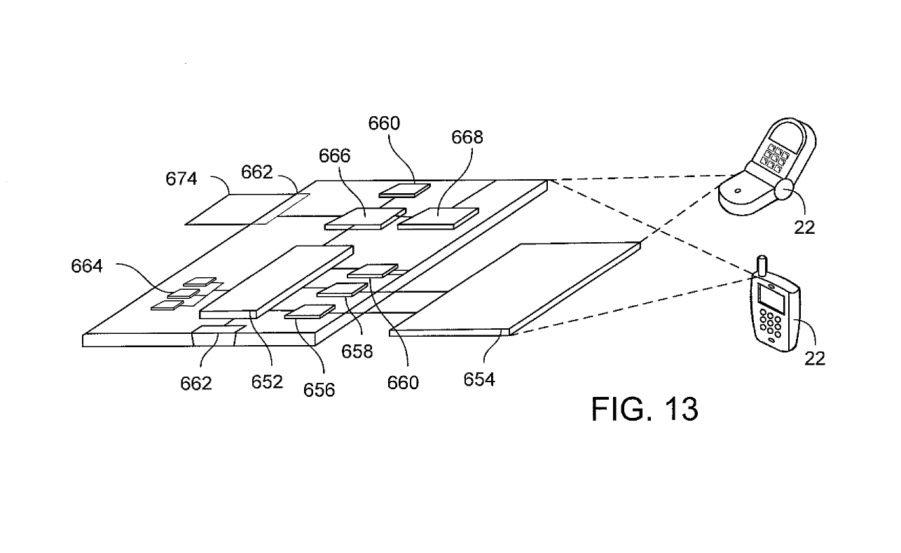

FIG. 13 illustrates an example of computing device 22 which is intended to represent various forms of mobile devices, such as personal digital assistants, cellular telephones, smartphones, tablets, notebook computers, laptop computers and other similar computing devices.

In the illustrated example, computing device 22 includes a processor 652, memory 664, an input/output device such as a display 654, a communication interface 666, and a transceiver 668, among other components. The device 22 also may be provided with a storage device, such as a microdrive or other device, to provide additional storage. The components 652, 664, 654, 666 and 668, are interconnected using various buses, and several of the components may be mounted on a common motherboard or in other manners as appropriate.

The processor 652 can execute instructions within the computing device 22, including instructions stored in the memory 664. The processor may be implemented as a chipset of chips that include separate and multiple analog and digital processors. Additionally, the processor may be implemented using any of a number of architectures. For example, the processor 652 may be a CISC (Complex Instruction Set Computers) processor, a RISC (Reduced Instruction Set Computer) processor, or a MISC (Minimal Instruction Set Computer) processor. The processor may provide, for example, for coordination of the other components of the device 22, such as control of user interfaces, applications run by device 22, and wireless communication by device 22.

Processor 652 may communicate with a user through control interface 658 and display interface 656 coupled to a display 654. The display 654 may be, for example, a TFT (Thin-Film-Transistor Liquid Crystal Display) display or an OLED (Organic Light Emitting Diode) display, or other appropriate display technology. The display interface 656 may comprise appropriate circuitry for driving the display 654 to present graphical and other information to a user. The control interface 658 may receive commands from a user and convert them for submission to the processor 652. In addition, an external interface 662 may be provided in communication with processor 652, so as to enable near-area communication of device 22 with other devices. External interface 662 may provide, for example, for wired communication in some implementations, or for wireless communication in other implementations, and multiple interfaces may also be used.

The memory 664 stores information within the computing device 22. The memory 664 can be implemented as one or more of a computer-readable medium or media, a volatile memory unit or units, or a non-volatile memory unit or units. Expansion memory 674 also may be provided and connected to device 22 through expansion interface 672, which may include, for example, a SIMM (Single In Line Memory Module) card interface. Such expansion memory 674 may provide extra storage space for device 22, or may also store applications or other information for device 22. Specifically, expansion memory 674 may include instructions to carry out or supplement the processes described above, and may include secure information also. Thus, for example, expansion memory 674 may be provided as a security module for device 22, and may be programmed with instructions that permit secure use of device 22. In addition, secure applications may be provided via the SIMM cards, along with additional information, such as placing identifying information on the SIMM card in a non-hackable manner.

The memory may include, for example, flash memory and/or NVRAM memory. In one implementation, a computer program product is tangibly embodied in an information carrier. The computer program product contains instructions that, when executed, perform one or more methods, such as those described above. The information carrier is a computer- or machine-readable medium, such as the memory 664, expansion memory 674, or memory on processor 652 that may be received, for example, over transceiver 668 or external interface 662.

Device 22 may communicate wirelessly through communication interface 666, which may include digital signal processing circuitry where necessary. Communication interface 666 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 668. In addition, short-range communication may occur, such as using a Bluetooth, WiFi, or other such transceiver (not shown). In addition, GPS (Global Positioning System) receiver module 670 may provide additional navigation- and location-related wireless data to device 22, which may be used as appropriate by applications running on device 22.

Device 22 also may communicate audibly using audio codec 660, which may receive spoken information from a user and convert it to usable digital information. Audio codec 660 may likewise generate audible sound for a user, such as through a speaker, e.g., in a handset of device 22. Such sound may include sound from voice telephone calls, may include recorded sound (e.g., voice messages, music tiles, etc.) and may also include sound generated by applications operating on device 22.

The computing device 22 also may include Universal Serial Bus (USB) flash drives, which may store operating systems and other applications. The USB flash drives can include input/output components, such as a wireless transmitter or USB connector that may be inserted into a USB port of another computing device. The components shown here, their connections and relationships, and their functions, are meant to be exemplary only, and are not meant to limit implementations of the inventions described and/or claimed in this document.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), peer-to-peer networks (having ad-hoc or static members), grid computing infrastructures, and the Internet.

A number of embodiments have been described. Nevertheless, it will be understood that various modifications may be made. For example, advantageous results may be achieved if the steps of the disclosed techniques were performed in a different sequence, if components in the disclosed systems were combined in a different manner, or if the components were replaced or supplemented by other components. Accordingly, other implementations are within the scope of the claims.

What is claimed is:

1. A system for managing healthcare-related communications, the system comprising;
a computer network; and
a server system comprising a portal that is accessible through the computer network;
wherein the server system includes a healthcare professional profile subsystem that is operable to perform operations including the following:
receive input through the portal from a first computing device, wherein the input indicates an availability status for a first healthcare professional;
store the availability status as part of a profile for the first healthcare professional; and
in response to receiving a request through the portal from a second healthcare professional, provide for viewing by the second healthcare professional a listing of one or more healthcare professionals, wherein the listing includes the name and availability status of the first healthcare professional.

2. The system of claim 1 wherein the server system is operable to provide information to be displayed on the first computing device, the information including a plurality of options from which the first healthcare professional can select an availability status to be stored by the server system as part of the profile for the first healthcare professional.

3. The system of claim 2 wherein the server system enables the first healthcare professional to select the availability status using a toggle switch or drop-down menu.

4. The system of claim 2 wherein the availability status indicates whether or not the first healthcare professional currently is available for a patient-related consultation or to perform a medical procedure or examination.

5. The system of claim 2 wherein the plurality of options from which the first healthcare professional can select include an indication that the first healthcare professional is on call or an indication that the first healthcare professional is on vacation.

6. The system of claim 1 wherein the server system stores or has access to a physician on-call schedule, wherein the listing of the one or more healthcare professionals includes information indicating which healthcare professional currently is on-call.

7. The system of claim 1 wherein the server system includes a messaging subsystem operable to store electronic message boxes each of which is associated with a respective one of a plurality of healthcare professionals registered with the server system, wherein the server system is operable to provide a listing of messages stored in the electronic message box associated with a particular healthcare professional, wherein the listing of messages includes status information indicating respective availability of at least some of the healthcare professionals who sent a message that is stored in the electronic message box.

8. The system of claim 1 wherein the computer network comprises the Internet.

9. A method of facilitating workflow management for healthcare professionals and enabling them to communicate, collaborate and share information, the method comprising:
receiving, from a first computing device, input through a portal of a server system, wherein the input indicates an availability status for a first healthcare professional;
storing, in the server system, the availability status as part of a profile for the first healthcare professional; and
in response to receiving a request through the portal from a second healthcare professional, providing for viewing by the second healthcare professional a listing of one or more healthcare professionals, wherein the listing includes the name and availability status of the first healthcare professional based on the stored profile of the first healthcare professional.

10. The method of claim 9 including providing information to be displayed on the first computing device, the information including a plurality of options from which the first healthcare professional can select an availability status to be stored by the server system as part of the profile for the first healthcare professional.

11. The method of claim 10 including enabling the first healthcare professional to select the availability status using a toggle switch or drop-down menu.

12. The method of claim 10 wherein the availability status indicates whether or not the first healthcare professional currently is available for a patient-related consultation or to perform a medical procedure or examination.

13. The method of claim 10 wherein the plurality of options from which the first healthcare professional can select include an indication that the first healthcare professional is on call or an indication that the first healthcare professional is on vacation.

14. The method of claim 9 including accessing a physician on-call schedule, wherein the listing of the one or more healthcare professionals includes information indicating which healthcare professional currently is on-call.

15. The method of claim 9 including causing to be displayed a listing of messages stored in an electronic message box associated with a particular healthcare professional, wherein the listing of messages includes status information indicating respective availability of at least some healthcare professionals who sent a message that is stored in the electronic message box.
